(19) United States
(12) Patent Application Publication
(10) Pub. No.: US 2026/0095701 A1
(43) Pub. Date: Apr. 2, 2026

(54) SPEAKER HAVING DUAL-COIL, DUAL-GAP, ELECTROMAGNETIC TRANSDUCER WITH ENHANCED SATURATED POLE TIPS

(71) Applicant: HARMAN INTERNATIONAL INDUSTRIES, INCORPORATED, Stamford, CT (US)

(72) Inventors: Chris N. HAGEN, Simi Valley, CA (US); An Duc NGUYEN, Simi Valley, CA (US)

(73) Assignee: HARMAN INTERNATIONAL INDUSTRIES, INCORPORATED, Stamford, CT (US)

(21) Appl. No.: 19/337,200

(22) Filed: Sep. 23, 2025

Related U.S. Application Data
(60) Provisional application No. 63/701,143, filed on Sep. 30, 2024.

(51) Int. Cl. H04R 9/02; H04R 9/04; H04R 9/06

(52) U.S. Cl. CPC H04R 9/025; H04R 9/045; H04R 9/06

(57) ABSTRACT

A magnetic assembly for a speaker includes a first pole piece having a first pole tip and a second pole piece having a second pole tip. The pole pieces are spaced apart with the pole tips being opposed across an air gap. Each pole tip is flared toward the air gap. The magnetic assembly may further include a first permanent magnet in contact with the first pole piece and a second permanent magnet in contact with the second pole piece. The magnetic assembly may be a part of an electromagnet transducer further having a voice coil positioned at least partially within the air gap.

### CROSS-REFERENCE TO RELATED APPLICATIONS

This application claims the benefit of U.S. Provisional Application No. 63/701,143, filed Sep. 30, 2024, the disclosure of which is hereby incorporated in its entirety by reference herein.

### TECHNICAL FIELD

The present disclosure relates to electromagnetic transducers of speakers and, more particularly, to a magnetic assembly configuration of such electromagnetic transducers.

### BACKGROUND

A speaker includes an electro-acoustical transducer operative to convert an electrical input into an acoustical output. The electro-acoustical transducer includes a magnetic assembly, a voice coil, and a diaphragm. The magnetic assembly and the voice coil cooperatively function as an electromagnetic transducer. In operation, the voice coil generates an electromagnetic field in response to being driven with the electrical input. The electromagnetic field interacts with a magnetic field of the magnetic assembly causing the voice coil to move. The diaphragm, which is coupled to the voice coil, moves as the voice coil moves thereby generating the acoustical output in the form of pressure sound waves.

### SUMMARY

A magnetic assembly for a speaker is provided. The magnetic assembly includes a first pole piece having a first pole tip and a second pole piece having a second pole tip. The pole pieces are spaced apart with the pole tips being opposed across an air gap. Each pole tip is flared toward the air gap.

The magnetic assembly may further include a first permanent magnet in contact with the first pole piece and a second permanent magnet in contact with the second pole piece. The first pole tip may be flared toward the air gap past the end of the first permanent magnet and the second pole tip may be flared toward the air gap past the end of the second permanent magnet.

Each pole tip may be flared toward the air gap by having a first tip portion extending along the air gap in a first direction from the pole tip and a second tip portion extending along the air gap in an opposite second direction from the pole tip. The pole tips may be flared symmetrically with respect to one another.

A speaker is also provided. The speaker includes a magnetic assembly including an annular central portion and an annular sleeve portion. The sleeve portion concentrically surrounds the central portion with an air gap spacing therebetween. The central portion includes a first pole piece having a first pole tip. The sleeve portion includes a second pole piece having a second pole tip. The pole tips are opposed across a first air gap that is a first part of the air gap spacing. Each pole piece other than the pole tip of the pole piece has a flat profile and the pole tip of the pole piece has a triangular shape including a first tip portion that extends along the first air gap in a first direction from the pole tip and a second tip portion that extends along the first air gap in an opposite second direction from the pole tip.

The speaker further includes a voice coil assembly including a bobbin having a first voice coil arranged thereon. The bobbin is movable relative to the magnetic assembly with the voice coil being positioned at least partially within the first air gap. The speaker further includes a diaphragm coupled to the bobbin to move as the bobbin moves.

The central portion may further include a first permanent magnet that is in contact with the first pole piece other than the first pole tip, and the sleeve portion may further include a second permanent magnet that is in contact with the second pole piece other than the second pole tip. In this case, the first permanent magnet has a first magnetic orientation, and the second permanent magnet has a second magnetic orientation opposite to the first magnetic orientation.

The sleeve portion may further include a ring having a first side that borders the first air gap and a second side that borders a portion of the second permanent magnet.

A dual-coil, dual-gap, electromagnetic transducer for a speaker is also provided. The electromagnetic transducer includes a magnetic assembly including an annular central portion and an annular sleeve portion. The sleeve portion concentrically surrounds the central portion with an air gap spacing therebetween. The central portion and the sleeve portion have a common center axis extending in an axial direction. The central portion includes a first top pole piece, a first top permanent magnet, a first central pole piece, a first bottom permanent magnet, and a first bottom pole piece that are stacked on one another in the recited order along the axial direction. The sleeve portion includes a second top pole piece, a second top permanent magnet, a second central pole piece, a second bottom permanent magnet, and a second bottom pole piece that are stacked on one another in the recited order along the axial direction. Each pole piece has a pole tip. The pole tips of the top pole pieces are opposed across a top air gap that is a first part of the air gap spacing. The pole tips of the bottom pole pieces being opposed across a bottom air gap that is a second part of the air gap spacing.

The electromagnetic transducer further includes a voice coil assembly including a bobbin having a first voice coil and a second voice coil arranged thereon. The bobbin is movable relative to the magnetic assembly with the first voice coil being positioned at least partially within the top air gap and the second voice coil being positioned at least partially within the bottom air gap.

The pole tips of the top pole pieces may be flared toward the top air gap. The pole tips of the bottom pole pieces may be flared toward the bottom air gap.

The first permanent magnets have a first magnetic orientation, and the second permanent magnets have an opposite second magnetic orientation. The first voice coil may be comprised of a first wiring that is wound in a first direction around a top portion of the bobbin and the second voice coil may be comprised of a second wiring that is wound in an opposite second direction around a bottom portion of the bobbin.

### BRIEF DESCRIPTION OF THE DRAWINGS

FIG. 1A illustrates a cross-sectional, isometric view of a speaker, the speaker including a dual-coil, dual-gap, electromagnetic transducer comprised from a magnetic assembly including first and second air gaps and a voice coil assembly including first and second voice coils;

FIG. 1B illustrates an enlarged view of the portion of FIG. 1A illustrating the electromagnetic transducer;

FIG. 2A illustrates a cross-sectional, cut angle view of the speaker;

FIG. 2B illustrates an enlarged view of the portion of FIG. 2A illustrating the electromagnetic transducer;

FIG. 3 illustrates a schematic, cross-sectional representation of the electromagnetic transducer;

FIG. 4 illustrates a cross-sectional view of the electromagnetic transducer with magnetic flux lines and relative intensity of the magnetic field of the magnetic assembly; and

FIG. 5 illustrates a graph of the intensity of the magnetic field of the magnetic assembly through the first and second air gaps of the magnetic assembly.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present disclosure.

Different naming conventions may be used to designate which pole of a magnet is the North pole. Permanent magnets include a magnetic polarity with a North pole defined as the pole of the magnet that, when free to rotate, seeks the North pole of the Earth. Magnets described as having opposite or complementary polarity have a North pole of the first magnet nearer to the South pole of the second magnet. Magnets described as having the same or similar polarity are aligned or positioned such that the North pole of the first magnet is nearer to the North pole of the second magnet. Those of ordinary skill in the art will understand that any reference made in the following description to directions such as top, bottom, up, down, etc., refer to the figure being described and may be different in an actual implementation depending on the orientation of the speaker as installed in an application.

Similarly, magnet orientation or alignment may be described with reference to positive (+) and negative (−) magnetic poles. A magnetometer may be used to identify magnetic polarity in terms of electromagnetic polarity, which is positive (+) and negative (−), rather than the geographic compass needle identification north and south. A north seeking compass needle, which is magnetic positive, may be used to identify a negative magnetic field of a static field permanent magnet. Positive and negative magnetic poles may be used to describe or designate the direction of flow of magnetic flux.

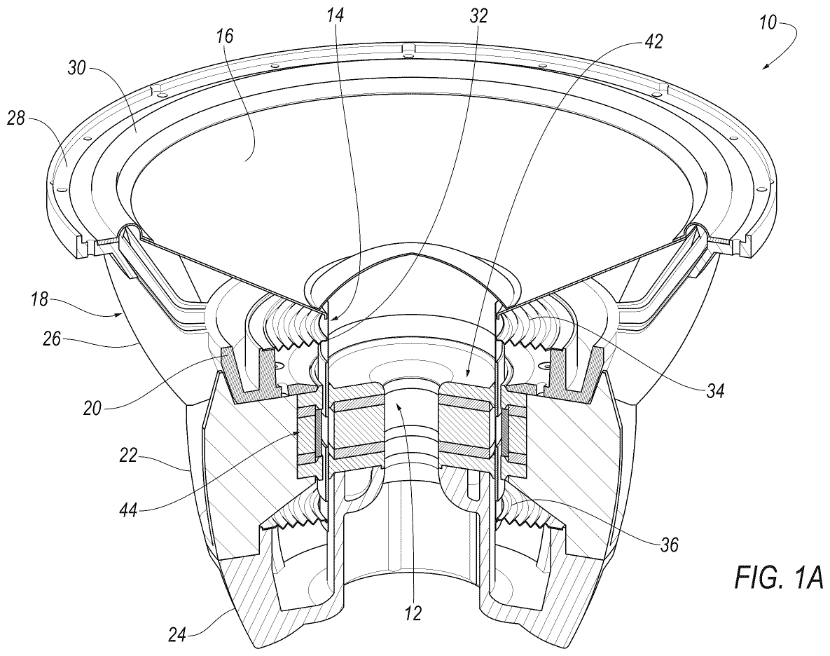

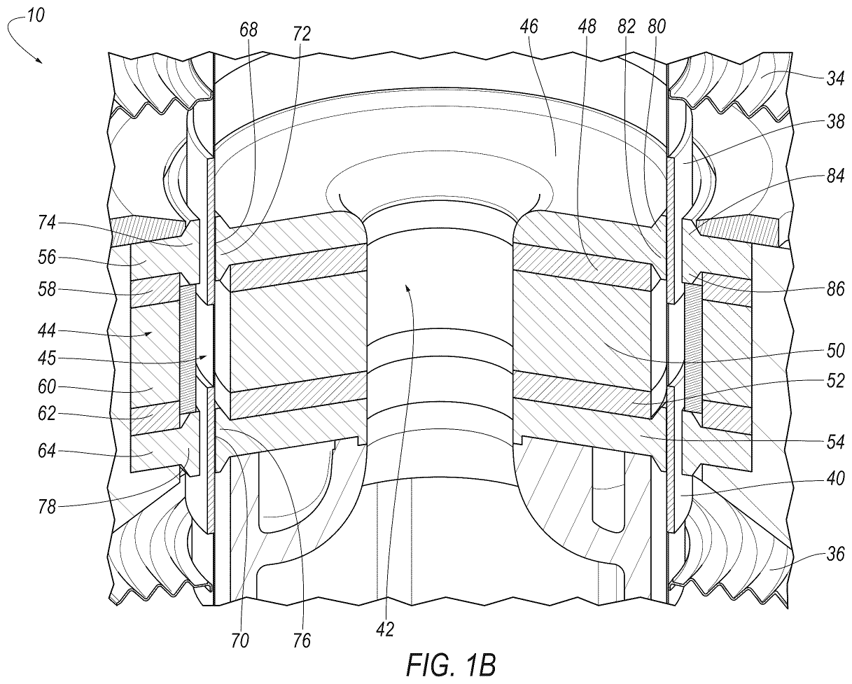

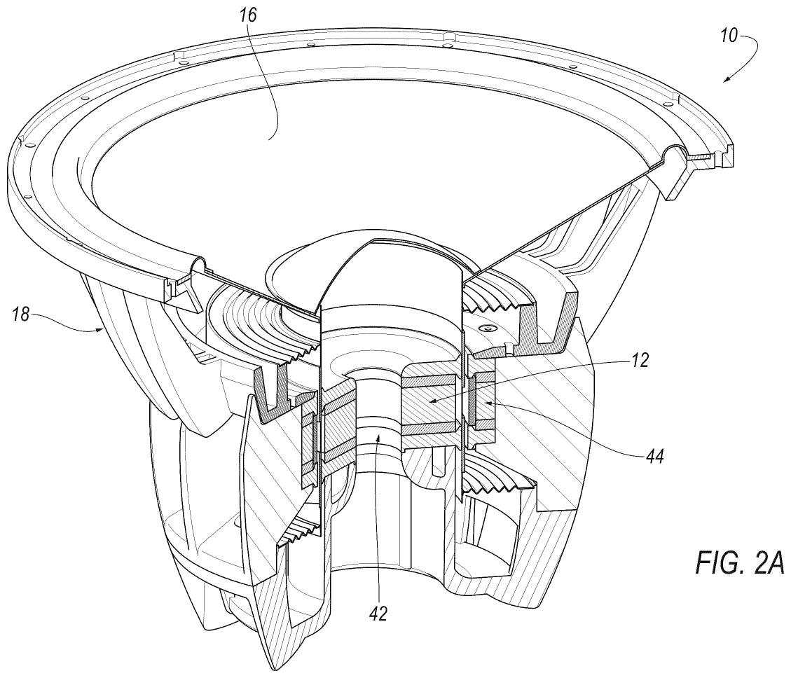

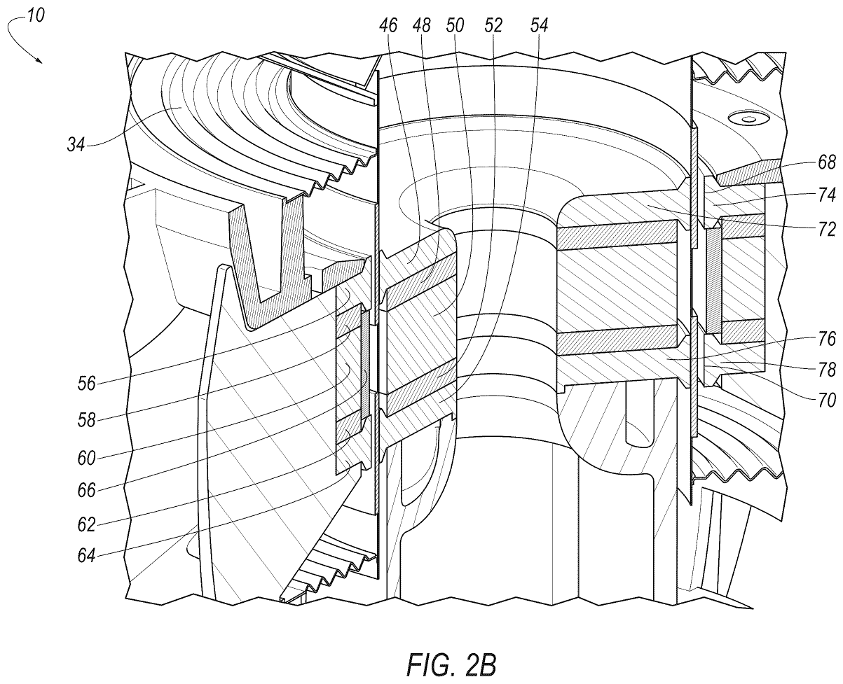

Referring now to FIGS. 1A and 2A, cross-sectional isometric and cut angle views of a speaker 10 are respectively shown. Speaker 10 includes an electro-acoustical transducer operative to convert an electrical audio signal input (i.e., an electrical representation of sound) into an acoustical output (i.e., the sound). The electro-acoustical transducer includes a magnetic assembly 12, a voice coil assembly 14, and a diaphragm 16. Magnetic assembly 12 and voice coil assembly 14 cooperatively function as an electromagnetic transducer (also referred to as a driver or a motor). FIGS. 1B and 2B illustrate enlarged views of the portions of FIGS. 1A and 2A, respectively, illustrating the electromagnetic transducer.

In operation, voice coil assembly 14 generates an electromagnetic field in response to being driven with an electrical audio signal input. The electromagnetic field is generated as a function of the electrical audio signal input. The electromagnetic field interacts with a magnetic field of magnetic assembly 12 causing voice coil assembly 14 to move. Diaphragm 16 (or cone) is coupled at one end to voice coil assembly 14. As diaphragm 16 is coupled to voice coil assembly 14, diaphragm 16 moves in correspondence with movement of voice coil assembly 14. The movement of diaphragm 16 generates an acoustical output in the form of pressure sound waves. In this way, the electromagnetic transducer comprised of magnetic assembly 12 and voice coil assembly 14 is operative to drive diaphragm 16 to generate an acoustical output corresponding to an electrical audio signal input.

In further detail, speaker 10 further includes a frame or a basket 18. Frame 18 includes a top base 20, a central base 22, and a bottom base 24 for supporting and securing magnetics assembly 12. Frame 18 further includes a connecting structure 26 and a mounting flange 28. Connecting structure 26 extends generally outward and upward from top base 20 to support mounting flange 28.

Diaphragm 16, in addition to being coupled at one end to voice coil assembly 14, is coupled at another end to frame 18. Diaphragm 16 is coupled to frame 18 at mounting flange 28. The coupling of diaphragm 16 to mounting flange 28 of frame 18 is by a surround 30. Surround 30 is a flexible suspension component. The coupling of diaphragm 16 to frame 18 via surround 30 allows diaphragm 16 to move axially along the direction of a central axis of speaker 10, while simultaneously precluding or minimizing lateral movement of diaphragm 16.

Voice coil assembly 14 is arranged to move axially with respect to magnetic assembly 12 in a reciprocating or oscillating manner, i.e., in anterior (i.e., upwards toward diaphragm 16) and posterior (i.e., downwards away from diaphragm 16) directions, along the central axis of speaker 10. The coupling of diaphragm 16 between voice coil assembly 14 and frame 18 enables diaphragm 16 to move axially in a reciprocating or oscillating manner in correspondence with the reciprocating or oscillating movement of voice coil assembly 14, while simultaneously precluding or minimizing lateral movement of diaphragm 16.

Voice coil assembly 14 includes a voice coil former or bobbin 32. Bobbin 32 is coupled to diaphragm 16. Particularly, the one end of diaphragm 16 that is coupled to voice coil assembly 14 is coupled to bobbin 32. Bobbin 32 is also coupled to frame 18. Particularly, a top portion of bobbin 32 is coupled to top base 20 of frame 18; and a bottom portion of bobbin 32 is coupled to bottom base 24 of frame 18. The top portion of bobbin 32 is coupled to top frame base 20 by a first spider 34; and the bottom portion of bobbin 32 is coupled to bottom frame base 24 by a second spider 36. Spiders 34 and 36 are flexible suspension components. The coupling of bobbin 32 to frame 18 via spiders 34 and 36 allows bobbin 32 to move axially with respect to magnetic assembly 12 along the direction of the central axis of speaker 10, while simultaneously precluding or minimizing lateral movement of bobbin 32.

Voice coil assembly 14 further includes a first voice coil 38 and a second voice coil 40. First and second voice coils 38 and 40 are distinct coils of wire. First and second voice coils 38 and 40 are axially spaced apart from one another along bobbin 32. First voice coil 38 is wound for a desired number of turns around the top portion of bobbin 32. Second voice coil 40 is wound for a desired number of turns around the bottom portion of bobbin 32. The number of turns may be the same or substantially the same.

The wires forming first and second voice coils 38 and 40 are wound around bobbin 32 in opposite directions. For instance, first voice coil 38 is wound in a clockwise direction around the top portion of bobbin 38 and second voice coil 40 is wound in a counterclockwise direction around the bottom portion of bobbin 32. By this configuration, electrical current of an electrical audio signal runs through first voice coil 38 in one direction and runs through second voice coil 40 in an opposite direction. In this way, the electric polarity of first and second voice coils 38 and 40 is reversed.

Magnetic assembly 12 includes a central portion 42 and a sleeve portion 44. Central portion 42 and sleeve portion 44 each have an annular shape and share the central axis of speaker 10 as a common center axis. Central portion 42 and sleeve portion 44 are physically separate from one another. Sleeve portion 44 concentrically surrounds central portion 42. In this way, sleeve portion 44 is an “outer” portion of magnetic assembly 12 and central portion 42 is an “inner” portion of magnetic assembly 12. As central portion 42 and sleeve portion 44 are physically separate from one another, central portion 42 and sleeve portion 44 form an air gap spacing 45 therebetween.

Central portion 42 and sleeve portion 44 each include a magnetic system. The magnetic systems generally have the same configuration. The magnetic system of central portion 42 includes a top pole piece 46, a top permanent magnet 48, a center pole piece 50, a bottom permanent magnet 52, and a bottom pole piece 54. In this listed order, components 46, 48, 50, 52, and 54 of central portion 42 are stacked in the axial direction from anterior to posterior. Particularly, top permanent magnet 48 is sandwiched between top and center pole pieces 46 and 50. Bottom permanent magnet 52 is sandwiched between center and bottom pole pieces 50 and 54. Components 46, 48, 50, 52, and 54 of central portion 42 have the annular shape of central portion 42 and are “inner” components as central portion 42 is the inner portion of magnetic assembly 12.

Likewise, the magnetic system of sleeve portion 44 includes a top pole piece 56, a top permanent magnet 58, a center pole piece 60, a bottom permanent magnet 62, and a bottom pole piece 64. In this listed order, components 56, 58, 60, 62, and 64 of sleeve portion 44 are stacked in the axial direction from anterior to posterior. Particularly, top permanent magnet 58 is sandwiched between top and center pole pieces 56 and 60. Bottom permanent magnet 62 is sandwiched between center and bottom pole pieces 60 and 64. Components 56, 58, 60, 62, and 64 of sleeve portion 44 have the annular shape of sleeve portion 44 and are “outer” components as sleeve portion 44 is the outer portion of magnetic assembly 12.

Permanent magnets 48 and 52 of central portion 42 and permanent magnets 58 and 62 of sleeve portion 44 may be any known type of permanent magnet. In this example, permanent magnets 48, 52, 58, and 62 are neodymium magnets. Further, as illustrated, permanent magnets 48, 52, 58, and 62 are plated neodymium magnets.

Pole pieces 46, 50, and 54 of central portion 42 and pole pieces 56, 60, and 64 of sleeve portion 44 may be of any material of high magnetic permeability that serves to direct a magnetic field produced by permanent magnets 48, 52, 58, and 62. In this example, pole pieces 46, 50, 54, 56, 60, and 64 are steel pole pieces.

The magnetic system of sleeve portion 44 further includes an additional component in the form of a ring 66. Ring 66 is positioned opposite from central portion 42. The inner side of ring 66 axially borders air gap spacing 45. The outer side of ring 66 axially borders a bottom portion of top permanent magnet 58, center pole piece 60, and a top portion of bottom permanent magnet 62 of sleeve portion 44. Ring 66 is, for example, an aluminum ring.

As shown, components 46, 48, 50, 52, and 54 of central portion 42 and counterpart components 56, 58, 60, 62, and 64 of sleeve portion 44 are symmetrically aligned along the axial direction. Components 46, 48, 50, 52, and 54 of central portion 42 and counterpart components 56, 58, 60, 62, and 64 of sleeve portion 44 face one another, respectively, across air gap spacing 45.

Air gap spacing 45 physically separates components 46, 48, 50, 52, and 54 of central portion 42 from counterpart components 56, 58, 60, 62, and 64 of sleeve portion 44. In this regard, top pole pieces 46 and 56 form a (top) magnetic air gap 68 therebetween, and bottom pole pieces 54 and 64 form a (bottom) magnetic air gap 70 therebetween. Particularly, top air gap 68 is between a tip 72 of top pole piece 46 and a tip 74 of top pole piece 56. Likewise, bottom air gap 70 is between a tip 76 of bottom pole piece 54 and a tip 78 of bottom pole piece 64.

Voice coil assembly 14, i.e., bobbin 32 with voice coils 38 and 40 arranged thereon, extends within air gap spacing 45. Voice coil assembly 14 extends within air gap spacing 45 such that at least one of voice coils 38 and 40 is positioned at least partially within top and bottom air gaps 68 and 70, respectively. As indicated above, first spider 34 and second spider 36 connect top and bottom portions of bobbin 32 with top and bottom bases 20 and 24 of frame 18, respectively. In this way, bobbin 32 is suspended relative to magnetic assembly 12 by first and second spiders 34 and 36 with first and second voice coils 38 and 40 being respectively positioned within top and bottom air gaps 68 and 70. As bobbin 32 is axially movable with respect to magnetic assembly 12, first voice coil 38 is axially movable relative to top air gap 68 in correspondence with axial movement of bobbin 32 and second voice coil 40 is axially movable relative to bottom air gap 70 in correspondence with the axial movement of bobbin 32.

As indicated, the electromagnetic transducer of speaker 10 is comprised of magnetic assembly 12 and voice coil assembly 14. As described, the electromagnetic transducer is a dual-coil, dual-gap, electromagnetic transducer. The electromagnetic transducer is “dual-coil” as voice coil assembly 14 includes first and second voice coils 38 and 40. The electromagnetic transducer is “dual-gap” as magnetic assembly 12 includes top and bottom air gaps 68 and 70.

A first feature of the configuration of magnetic assembly 12 is that the tips of the top and bottom pole pieces are flared toward the air gaps to be relatively enlarged along the air gaps as compared to the remaining portions of the pole pieces, as shown in FIGS. 1A, 1B, 2A, and 2B. The flared profile of the tip (“pole tip”) of a pole piece is a sort of a truncated, triangular shape in which a top tip portion extends axially upward from the pole tip and a bottom tip portion extends axially downward from the pole tip. The flared profiles of the tips of opposing pole pieces are generally symmetrical with respect to one another.

As such, with respect to top air gap 68, inner pole tip 72 of top pole piece 46 and outer pole tip 74 of top pole piece 56 are flared to be relatively enlarged. Pursuant to the flared profile, a top tip portion 80 extends axially upward from inner pole tip 72 and a bottom tip portion 82 extends axially downward from inner pole tip 72. Likewise, pursuant to the flared profile, a top tip portion 84 extends axially upward from outer pole tip 74 and a bottom tip portion 86 extends axially downward from outer pole tip 74. The flaring profile of pole tips 72 and 74 allows for more excursion of first voice coil 38 across top air gap 68 as compared to pole tips not having such flared profile.

In similar manner, with respect to bottom air gap 70, inner pole tip 76 of bottom pole piece 54 and outer pole tip 78 of bottom pole piece 64 are also flared. The flaring profile of pole tips 76 and 78 allows for relatively more excursion of second voice coil 40 across bottom air gap 70.

As described and illustrated, the pole tips are flared toward the air gaps. In the example illustrated, the pole tips are flared toward the air gaps past the ends of the permanent magnets.

A second feature of the configuration of magnetic assembly 12 is that sleeve portion 44 includes at least one permanent magnet. That is, instead of solely being a pole piece, e.g., instead of being a component formed entirely of steel, sleeve portion 44 includes top permanent magnet 58 and bottom permanent magnet 62.

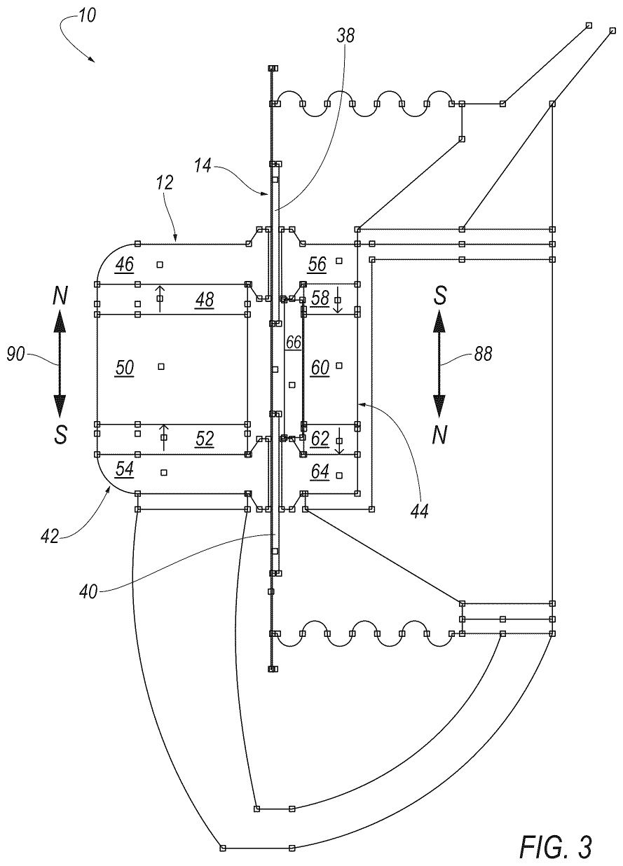

As described above, top and bottom permanent magnets 58 and 62 of sleeve portion 44 are axially aligned with top and bottom permanent magnets 48 and 52 of central portion 42. Top permanent magnets 48 and 56 are associated with top air gap 68. Bottom permanent magnets 52 and 62 are associated with bottom air gap 70. Permanent magnets 48 and 52 of central portion 42 are positioned with the same first magnetic polarity 88 (reference numeral shown in FIG. 3). Permanent magnets 58 and 62 of sleeve portion 44 are positioned with the same second magnetic polarity 90 (reference numeral shown in FIG. 3) opposite to first magnetic polarity 88. As such, the polarity of magnetic fields of central portion 42 and of sleeve portion 44 are reversed.

In this way, magnetic assembly 12 generates a magnetic field which extends in central portion 42 from top pole piece 46 to top permanent magnet 48 to center pole piece 50 to bottom permanent magnet 52 to bottom pole piece 54, across bottom air gap 70, in sleeve portion 44 from bottom pole piece 64 to bottom permanent magnet 62 to center pole piece 60 to top permanent magnet 58 to top pole piece 56, and across top air gap 68 returning to top pole piece 46 of central portion 42.

As described, top pole pieces 46 and 56 associated with top air gap 68 and bottom pole pieces 54 and 64 associated with bottom air gap 70 have enlarged air gap pole tips, per the first feature of the configuration of magnetic assembly 12, and sleeve portion 44 includes top and bottom permanent magnets 58 and 62 having a magnetic polarity opposite to that of central portion 42, per the second feature of the configuration of magnetic assembly 12.

The enlarged air gap pole tips associated with an air gap, per the first feature, provides for more excursion of the associated voice coil across the air gap. For instance, the enlarged air gap pole tips of top pole pieces 46 and 56 provides for more excursion of first voice coil 38 across top air gap 68. Likewise, the enlarged air gap pole tips of bottom pole pieces 54 and 64 provides for more excursion of second voice coil 40 across bottom air gap 70. However, the enlarged air gap pole tips tend to cause the strength of the magnetic field extending across the associated air gap to decrease.

The addition of a permanent magnet in sleeve portion 44 adjacent to an air gap associated with enlarged air gap pole tips, per the second feature, increases the strength of the magnetic field extending across the associated air gap. For instance, top permanent magnet 58 in sleeve portion 44 adjacent to top air gap 68 increases the strength of the magnetic field extending across the top air gap. Likewise, bottom permanent magnet 64 in sleeve portion 44 adjacent to bottom air gap 70 increases the strength of the magnetic field extending across the bottom air gap.

As an aside, the first and second features of magnetic assembly 12 have been described in the context of a dual-coil, dual-gap, electromagnetic transducer. As such, the first feature provides for two pairs of enlarged air gap pole tips and the second feature provides for two permanent magnets incorporated into the sleeve portion. Of course, if desired, for such a dual-coil, dual-gap, electromagnetic transducer, only one pair of enlarged air gap pole tips may be provided for either of the two air gaps and/or only one permanent magnet may be incorporated into the sleeve portion adjacent to either of the two air gaps. Similarly, the first and second features of magnetic assembly 12 are applicable in the context of a single-coil, single-gap electromagnetic transducer. In this case, the first feature provides for one pair of enlarged air gap pole tips and the second feature provides for one permanent magnet incorporated into the sleeve portion.

Compared to the configuration of magnetic assembly 12, a conventional magnetic assembly includes the following attributes. The conventional magnetic assembly includes a permanent magnet(s) only in the central portion. That is, the conventional magnetic assembly does not include a permanent magnet in the sleeve portion. Additionally, the sleeve portion of the conventional magnetic assembly is entirely comprised of pole material (e.g., the sleeve portion is just a cylinder of steel). In the conventional magnetic assembly, the pole pieces of the central and sleeve portions are flat (e.g., the pole pieces are flat pieces of steel). This allows an air gap to come closer together than the centers of the pole pieces, typically residing at the surface where a permanent magnet and a pole piece, in the central portion, meet. This and the pole piece thickness restrict the amount of excursion that the diaphragm, via the voice coil assembly, can move through. Further, with this style of motor (i.e., closely spaced steel with energetic magnets), there is more leakage of the magnetic field between the air gap spacing from the sleeve portion to the central portion, causing an asymmetric magnetic field and more distortion.

As described, in magnetic assembly 12, the magnetic field strength is increased by adding permanent magnets 58 and 62 into sleeve portion 44. These additional magnets (i.e., “secondary magnets”) drive the enlarged tips of pole pieces 46, 56 and 54, 64 to saturation, lowering distortion. The enlarged pole tips allow for more excursion than flat pole pieces. The enlarged pole tips help better define the area of the air gaps and keep air gap spacing 45 to a designed amount. The better-defined air gaps along with additional spacing, via air gap spacing 45, between central portion 42 and sleeve portion 44 reduce the magnetic flux leakage and make for more symmetrical magnetic field lines in the air gaps and for this, lower distortion.

In sum, in magnetics assembly 12, the flaring profile of the pole tips in combination with the permanent magnets in the sleeve portion provides for enhancing magnetic field strength and fidelity across the air gaps as compared to pole tips not having such flared profile and the sleeve portion not having such permanent magnets. In this way, the dual-coil, dual-gap, electromagnetic transducer comprised of magnetics assembly 12 is a dual coil drive with enhanced saturated pole tips or, more succinctly, an enhanced dual coil motor.

Referring now to FIG. 3, with continual reference to the preceding Figures, a schematic, cross-sectional representation of the dual-coil, dual-gap, electromagnetic transducer is shown. In this example, the material of the pole pieces of both central portion 42 and sleeve portion 44 is steel, such as “1010” steel; and the material of the permanent magnets of both central portion 42 and sleeve portion 44 is neodymium, such as “40” neodymium. The wires of both voice coils 38 and 40 may be copper-clad aluminum (CCA) conductors such as “23 AWG 10% CCA” conductors. In this example, the material of ring 66 is aluminum such as “1100” aluminum.

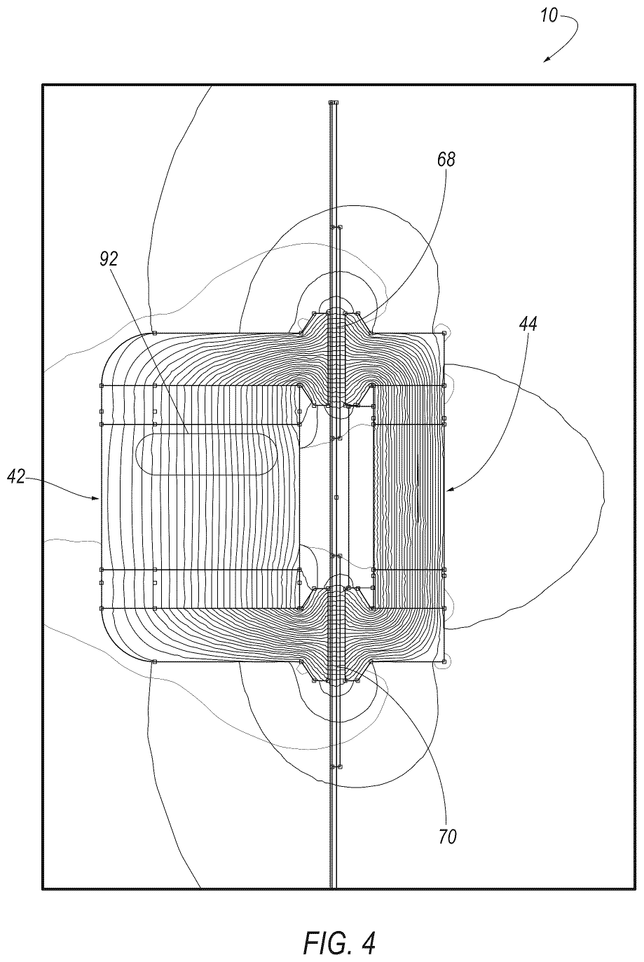

Referring now to FIG. 4, with continual reference to the preceding Figures, a cross-sectional view of the electromagnetic transducer with magnetic flux lines 92 and relative intensity of the magnetic field of magnetic assembly 12 is shown. Of note, is the relative uniformity of magnetic flux lines 92 with relatively minimal loss. Further of note is the symmetric magnetic flux lines 92 extending across top and bottom air gaps 68 and 70.

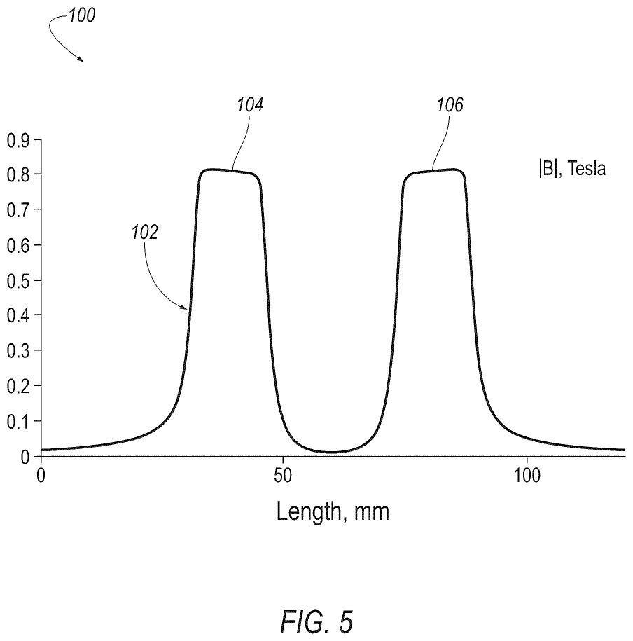

Referring now to FIG. 5, with continual reference to FIG. 4, a graph 100 having a plot 102 of the intensity of the magnetic field of magnetic assembly 12 through top and bottom air gaps 68 and 70 is shown. A first peak 104 of plot 102 is indicative of the intensity (measured along the y-axis of graph 100) of the magnetic field through top air gap 68 and a second peak 106 of plot is indicative of the intensity of the magnetic field through bottom air gap 70.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A magnetic assembly for a speaker, comprising:
a first pole piece having a first pole tip;
a second pole piece having a second pole tip;
the pole pieces being spaced apart with the pole tips being opposed across an air gap; and
wherein each pole tip is flared toward the air gap.

2. The magnetic assembly of claim 1 further comprising:
a first permanent magnet in contact with the first pole piece; and
a second permanent magnet in contact with the second pole piece.

3. The magnetic assembly of claim 2 wherein:
the permanent magnets are spaced apart farther than the pole pieces are spaced apart with an end of the first permanent magnet and an end of the second permanent magnet being opposed; and
the first pole tip is flared toward the air gap past the end of the first permanent magnet and the second pole tip is flared toward the air gap past the end of the second permanent magnet.

4. The magnetic assembly of claim 1 wherein:
each pole tip is flared toward the air gap by having a first tip portion extending along the air gap in a first direction from the pole tip and a second tip portion extending along the air gap in an opposite second direction from the pole tip.

5. The magnetic assembly of claim 1 wherein:
the pole tips are flared symmetrically with respect to one another.

6. The magnetic assembly of claim 1 further comprising:
a central portion and a sleeve portion, the sleeve portion concentrically surrounding the central portion with an air gap spacing therebetween;
wherein the air gap is a first air gap and is a first part of the air gap spacing; and
the first pole piece is arranged in the central portion and the second pole piece is arranged in the sleeve portion.

7. The magnetic assembly of claim 6 further comprising:
a first permanent magnet arranged in the central portion, the first permanent magnet being in contact with the first pole piece; and
a second permanent magnet arranged in the sleeve portion, the second permanent magnet being in contact with the second pole piece.

8. The magnetic assembly of claim 7 further comprising:
a first central pole piece arranged in the central portion, the first permanent magnet being sandwiched between the first pole piece and the first central pole piece; and
a second central pole piece arranged in the sleeve portion, the second permanent magnet being sandwiched between the second pole piece and the second central pole piece.

9. The magnetic assembly of claim 6 further comprising:
a third pole piece arranged in the central portion, the third pole piece having a third pole tip;
a fourth pole piece arranged in the sleeve portion, the fourth pole piece having a fourth pole tip;
the third and fourth pole tips being opposed across a second air gap, the second air gap being a second part of the air gap spacing; and
wherein each of the third and fourth pole tips is flared toward the second air gap.

10. The magnetic assembly of claim 9 further comprising:
a first permanent magnet, a first central pole piece, and a third permanent magnet arranged in the central portion, the first permanent magnet being sandwiched between the first pole piece and the first central pole piece, and the third permanent magnet being sandwiched between the first central pole piece and the third pole piece; and
a second permanent magnet, a second central pole piece, and a fourth permanent magnet arranged in the sleeve portion, the second permanent magnet being sandwiched between the second pole piece and the second central pole piece, and the fourth permanent magnet being sandwiched between the second central pole piece and the fourth pole piece.

11. A speaker comprising:
a magnetic assembly including an annular central portion and an annular sleeve portion, the sleeve portion concentrically surrounding the central portion with an air gap spacing therebetween, the central portion including a first pole piece having a first pole tip, the sleeve portion including a second pole piece having a second pole tip, the pole tips being opposed across a first air gap that is a first part of the air gap spacing, each pole piece other than the pole tip of the pole piece has a flat profile and the pole tip of the pole piece has a triangular shape including a first tip portion that extends along the first air gap in a first direction from the pole tip and a second tip portion that extends along the first air gap in an opposite second direction from the pole tip;
a voice coil assembly including a bobbin having a first voice coil arranged thereon, the bobbin being movable relative to the magnetic assembly with the voice coil being positioned at least partially within the first air gap; and
a diaphragm coupled to the bobbin to move as the bobbin moves.

12. The speaker of claim 11 wherein:
the central portion further includes a first permanent magnet that is in contact with the first pole piece other than the first pole tip; and
the sleeve portion further includes a second permanent magnet that is in contact with the second pole piece other than the second pole tip.

13. The speaker of claim 12 wherein:
the first permanent magnet has a first magnetic orientation; and
the second permanent magnet has a second magnetic orientation opposite to the first magnetic orientation.

14. The speaker of claim 12 wherein:
the sleeve portion further includes a ring, the ring including a first side that borders the first air gap and a second side that borders a portion of the second permanent magnet.

15. The speaker of claim 12 wherein:
the central portion further includes a first central pole piece, the first permanent magnet being sandwiched between (i) the first pole piece other than the first pole tip and (ii) the first central pole piece; and
the sleeve portion further includes a second central pole piece, the second permanent magnet being sandwiched between (i) the second pole piece other than the second pole tip and (ii) the second central pole piece.

16. The speaker of claim 11 wherein:
the central portion further includes a third pole piece having a third pole tip, the sleeve portion further includes a fourth pole piece having a fourth pole tip, the third and fourth pole tips being opposed across a second air gap that is a second part of the air gap spacing, each pole piece other than the pole tip of the pole piece has a flat profile and the pole tip has a triangular shape including a third tip portion that extends along the second air gap in the first direction from the pole tip of the third pole piece and a fourth tip portion that extends along the second air gap in the opposite second direction from the fourth pole tip.

17. The speaker of claim 16 wherein:
the bobbin further including a second voice coil arranged thereon, the second voice coil being positioned at least partially within the second air gap; and
the first voice coil is comprised of a first wiring that is wound in a first direction around a first portion of the bobbin and the second voice coil is comprised of a second wiring that is wound in an opposite second direction around a second portion of the bobbin.

18. A dual-coil, dual-gap, electromagnetic transducer for a speaker, comprising:
a magnetic assembly including an annular central portion and an annular sleeve portion, the sleeve portion concentrically surrounding the central portion with an air gap spacing therebetween, the central portion and the sleeve portion having a common center axis extending in an axial direction;
the central portion including a first top pole piece, a first top permanent magnet, a first central pole piece, a first bottom permanent magnet, and a first bottom pole piece that are stacked on one another in the recited order along the axial direction;
the sleeve portion including a second top pole piece, a second top permanent magnet, a second central pole piece, a second bottom permanent magnet, and a second bottom pole piece that are stacked on one another in the recited order along the axial direction;
each pole piece having a pole tip, the pole tips of the top pole pieces being opposed across a top air gap that is a first part of the air gap spacing;
the pole tips of the bottom pole pieces being opposed across a bottom air gap that is a second part of the air gap spacing; and
a voice coil assembly including a bobbin having a first voice coil and a second voice coil arranged thereon, the bobbin being movable relative to the magnetic assembly with the first voice coil being positioned at least partially within the top air gap and the second voice coil being positioned at least partially within the bottom air gap.

19. The dual-coil, dual-gap, electromagnetic transducer of claim 18 wherein:
the pole tips of the top pole pieces are flared toward the top air gap; and
the pole tips of the bottom pole pieces are flared toward the bottom air gap.

20. The dual-coil, dual-gap, electromagnetic transducer of claim 18 wherein:
the first permanent magnets have a first magnetic orientation, and the second permanent magnets have an opposite second magnetic orientation; and
the first voice coil is comprised of a first wiring that is wound in a first direction around a top portion of the bobbin and the second voice coil is comprised of a second wiring that is wound in an opposite second direction around a bottom portion of the bobbin.
